(19) United States
(12) Patent Application Publication
(10) Pub. No.: US 2005/0268646 A1
(43) Pub. Date: Dec. 8, 2005

(54) Novel biological treating agent

(76) Inventors: James T.C. Yuan, Naperville, IL (US); Meenakshi Sundaram, Burr Ridged, IL (US); Yves P. Bourhis, Westmont, IL (US); Edward F. Steiner, Downers Grove, IL (US); Steven A. Fisher, Brookfield, IL (US); Vasuhi Rasanayagam, Chicago, IL (US)

Correspondence Address: AIR LIQUIDE, 2700 POST OAK BOULEVARD, SUITE 1800, HOUSTON, TX, 77056, US

(21) Appl. No.: 11/145,137

(22) Filed: Jun. 3, 2005

Related U.S. Application Data
(63) Continuation-in-part of application No. 10/632,232, filed on Jul. 31, 2003.
(60) Provisional application No. 60/404,635, filed on Aug. 20, 2002.
(60) Provisional application No. 60/459,398, filed on Apr. 1, 2003.

(51) Int. Cl. A23B 4/00; A21D 4/00; A23L 3/34; A23C 3/00; F24F 3/16; C12H 1/10; A23K 3/00; F25J 1/00

(52) U.S. Cl. 62/602; 62/604; 62/78

(57) ABSTRACT

Methods for treating, and/or cooling of a target item to reduce or eliminate biological microorganisms in or on a target item. The treating agent of the invention is particularly useful for treating food products, food storage, and food transportation devices as well as treating water, or other target objects. A treating agent containing a sanitizing agent entrapped by or absorbed in or on a cooling agent is used when processing, transporting, displaying, or storing of target items. The treating agent can be used to chill and preserve target items while providing the added benefit of sanitizing the target item. The novel processes of the current invention provide for using a treating agent to process, store, or package target items using a treating agent containing a cooling agent, such as solid carbon dioxide (“dry ice”), and a sanitizing agent, such as ozone.

### CROSS-REFERENCE TO RELATED APPLICATIONS

This application is a continuation in part of and claims priority to U.S. application Ser. No. 10/632,232, filed Jul. 31, 2003, which is a non-provisional application claiming priority of U.S. Provisional application 60/404,635, filed Aug. 20, 2002, and U.S. Provisional application 60/459,398, filed Apr. 1, 2003. The entire contents of these applications are herby incorporated by these references.

### BACKGROUND

Treating and sanitation of food, equipment, pharmaceutical products, and even water to reduce undesirable biological microorganisms is important to the protection of public health. For example, food can be damaged by microbes, spores, insects, and other similar sources. Each year, economic losses of food, and labor due to damage from such sources, is more than $100 billion. Currently, food items are preserved using a variety of methods, including refrigeration, fumigation with toxic chemicals, irradiation, biological control, heat exposure, and controlled atmosphere storage (a fruit industry technique that involves modifying the concentration of gases naturally present in the air).

The primary problem regarding food spoilage in public health is microbial growth. If pathogenic microorganisms are present, then growth can potentially lead to food-borne outbreaks and significant economic losses. Food safety concerns have been brought to the consumers' attention since the early part of the 20^{th} century and those concerns have become even stronger today. Outbreaks from Salmonella and E. coli have increased the focus on food safety, including from a regulatory perspective. A study completed by the Centers for Disease Control and Prevention (CDC) estimated that food-borne diseases cause approximately 76 million illnesses, 325,000 hospitalizations and 5,000 deaths annually in the US. Those numbers reveal the dramatic need for effective means of handling food products in order to ensure food safety.

Effective sanitation of food or other items depends on the combination of what is to be sanitized and the sanitation process type. Not all of the currently available technologies can deliver an effective reduction of microorganisms and at the same time prevent product or environmental degradation. It is well known in the art to cool products, such as foods, during processing with some type of refrigerant to slow down the growth of unwanted microbes and enzymatic reactions in foods. For instance, the shelf life and quality of food products are improved by processing, transporting, and storing under refrigerated conditions.

Cooling agents, such as dry ice, carbon dioxide, or nitrogen, are liquid or solid agents that can be used as an expendable refrigerant. Water ice is a traditional expendable refrigerant, but has the disadvantage of converting to water after the ice melts. Some solid cooling agents convert from a solid directly to a gas in the process known as sublimation. For example, dry ice sublimes by going directly from a solid to a gas without passing through the liquid stage. The cold temperature of dry ice and the fact that it leaves no residue like water ice makes it an excellent refrigerant in some applications. When transporting food products that must remain frozen during transportation, the food can be packed with dry ice. The contents will be frozen when they reach their destination and there will be no messy liquid left over like traditional water ice. In food processing applications, liquids, such as nitrogen, are used to cool and inert the atmosphere during food processing or storage.

While refrigeration can retard microbial growth, such treatment does not necessarily kill bacteria. Accordingly, microorganisms can still survive through refrigeration, and worse, some microorganisms can still grow and produce harmful substances during refrigerated storage. Furthermore, it is possible that the refrigerant used to cool a target item or food product can itself be contaminated with pathogenic microorganisms, thus contaminating the target item or food product.

Biocidal agents are used to sanitize equipment, provide antiseptic environments, treat water, and sanitize foods. The reaction of biocidal agents with microbial cell structures is often irreversible; therefore the cells either become attenuated or die.

One biocidal agent commonly used in the industry is ozone. However, ozone is very unstable and therefore must be produced at the location of consumption. Production of ozone requires specialized equipment and involves safety issues due to handling of the equipment and feedstock, such as pure oxygen. After the ozone is produced, it must be delivered in some form to the target item as a sanitizer. Ozone is often dissolved or absorbed in water as a mechanism to deliver the unstable ozone to a target item. However, ozone has poor solubility in water. Mixtures of ozone and water typically contain less than about 20 ppm by weight ozone. As a result, large quantities of water relative to the ozone are required if water is used as a delivery agent. Furthermore, because of the large quantities of water required, the ozone and water cannot be pre-mixed and transported to site. Thus, ozone and water must be mixed on site.

Another problem with ozone is the difficulty in compressing an ozone-containing stream. Ozone generating equipment known in the art can produce an ozone-containing gas stream at low pressure. These ozone generators are typically limited to producing a stream with a pressure of less than about 25 psig. Conventional mechanical compression cannot be used to compress ozone because the unstable ozone molecule is destroyed in conventional compressors. Water ring compression can be used to compress a stream containing ozone up to 150 psig, however water ring compressors inherently contaminate the ozone stream with water. Therefore, the prior art fails to provide a method to compress the ozone to pressures above about 25 psig without contaminating the ozone stream with some level of water. Furthermore, the prior art fails to provide any method to successfully compress an ozone stream to pressures of greater than about 150 psig without destroying the ozone.

Water treating often involves the use of biocidal agents as well as other chemicals to adjust the pH of the water. This is typically accomplished by adding one chemical as a biocide and a separate chemical to adjust the pH. It is well known in the art that CO₂ is one chemical that can be used to adjust the pH of water. Furthermore, it is known that ozone can be used as a biocidal agent.

It is desirable to sanitize equipment or devices and process foods using a combination of the cooling properties of cooling agents with the biological destruction capability of biocidal agents. It is further desirable that the cooling agent and the biocidal agents be exposed to the equipment or food product substantially simultaneously. In addition, it is desirable to be able to produce ozone in a treating product that is transportable so that the user is not faced with having to produce ozone at site. It is also desirable to use cooling agents that will not contaminate the target equipment or foods in the process of attempting to treat them. Further yet, it is desirable in some processes, such as water treating, to adjust the pH of a target item while simultaneously treating the item for undesirable microbes.

### SUMMARY OF THE INVENTION

This invention addresses the need to cool, treat, or sanitize equipment, devices, water, food or food products, or other target items. Additionally, the invention addresses the need to be able to store and transport unstable biocidal agents, particularly ozone so that the end user does not have to produce unstable biocidal agents or mix biocidal agents with delivery agents at site. The invention also addresses the need to be able to treat water with a biocidal agent while simultaneously adjusting the pH of the water. The process uses a treating agent that contains a cooling agent for cooling or otherwise treating an item and a sanitizing agent to reduce microbial growth in or on the item. Combining the effects of cooling and sanitizing provides maximum biocidal efficiency to reduce biological growth and ensure pathogenic safety.

The current invention provides a treating agent, a packaged product, and a method of treating a target item by exposing the item to a treating agent. The treating agent of the current invention contains a sanitizing agent and a cooling agent. The treating agent is preferably in a solid form, a liquid form, or a mixture of solid and liquid form when initially exposed to the item or equipment. Furthermore, the treating agent is substantially absent water. The sanitizing agent is present in the treating agent while the treating agent is in a solid or liquid form. The cooling agent is preferably a liquefied gas, a solid made from liquefied gas, or a combination of the liquefied gas and solids. As the cooling agent sublimes or vaporizes, the sanitizing agent is released or transported and sanitizes the target item or equipment. The treating agent of the current invention can be stored and transported in a form that is directly usable by the end user without having to mix or produce chemicals at site.

In other preferred embodiments:
the cooling agent is in solid form and converts to a gaseous form as heat is absorbed by the treating agent;
the cooling agent is N₂, CO₂, or mixtures thereof;
the sanitizing agent is ozone, chlorine dioxide, hydrogen peroxide, chlorine, or mixtures thereof;
the treating agent contains greater than about 1 ppm by weight sanitizing agent;
the treating agent contains greater than about 2 ppm by weight sanitizing agent;
the treating agent contains about 1 to 20 ppm by weight ozone;
the treating agent contains greater than about 20 ppm by weight ozone;
the treating agent is in a liquid form and contains greater than about 50 ppm by weight ozone;
the cooling agent is liquefied CO₂; and/or
the sanitizing agent substantially sanitizes said cooling agent.

The current invention also provides a method of processing a target item, such as a food product, by:
a) exposing a target item to a treating agent described above;
b) converting the cooling agent to a gaseous form; and
c) treating the target item with the sanitizing agent.

In other preferred embodiments:
a target item is in a treatment area that is a tunnel, a tumbler, a blender, a plate, a chamber, a vessel, a package, or combinations thereof when exposed to the treating agent;
the sanitizing agent contains ozone and the sanitizing agent is compresses in a dry gas compression system; and/or
the pH of the target item is adjusted.

The current invention also provides a packaged item, such as a food product, by placing the item into a package and adding a treating agent as described above to the package.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic of one process embodiment for treating a target item according to the current invention;

FIG. 2 is a schematic of a second process embodiment treating a target item;

FIG. 3 is a schematic of one packaged product embodiment of the current invention;

FIG. 4 is a schematic of one process embodiment for producing a product of the current invention;

FIG. 5 is a schematic of a second process embodiment for producing a product; and

FIG. 6 is a graph showing the concentrations of sanitizing agent in one embodiment of the invention.

### DESCRIPTION OF PREFERRED EMBODIMENTS

The current invention provides a treating agent, a packaged product incorporating a treating agent, and a process for cooling, sanitizing, or otherwise treating a target item by using a treating agent. The treating agent of the current invention contains a cooling agent and a sanitizing agent to reduce microbial growth on and in the target item. The current invention is particularly useful for processing, transporting, and storing food products, for sanitizing equipment, and for sanitizing objects such as food utensils or medical devices. The treating agent of the current invention can be stored and transported in a form that is directly usable by the end user without having to mix or produce chemicals at site. The treating agent of the current invention can also be used to treat a liquid, such as water, with a biocidal agent while simultaneously adjusting the pH of the liquid.

One aspect of the current invention provides a product that is a treating agent comprising a cooling agent and a sanitizing agent as described herein. The treating agent may be in solid or liquid form. While not being bound by any particular theory, it is believed that in a solid form treating agent, the sanitizing agent is present in, or fixed to the solid cooling agent until the solid cooling agent sublimes or vaporizes. Similarly, the sanitizing agent is present in the liquid cooling agent until the liquid cooling agent vaporizes or the pressure is reduced in the liquid. Vaporization or sublimation of the cooling agent occurs as the treating agent absorbs heat from the target item or the surrounding environment, or as the pressure drops. The treating agent preferably contains varying amounts of sanitizing agent depending on the cooling agent, the form of the treating agent, and the particular sanitizing agent utilized. One embodiment of a solid treating agent uses at least about 0.1 ppm by weight (ppmw) sanitizing agent, more preferably at least about 1 ppmw sanitizing agent, even more preferably greater than about 2 ppm sanitizing agent, and even further preferably at least about 20 ppmw sanitizing agent. Another embodiment uses about 1 to 100 ppmw sanitizing agent, and another yet uses about 1 to 20 ppmw sanitizing agent. One preferred embodiment of a liquid treating agent contains greater than, about 50 ppmw ozone. An embodiment of a liquid form treating agent containing ozone and CO₂ contains concentrations of greater than about 200 ppmw ozone and preferably contains levels of between about 200 and 400 ppmw ozone. One preferred treating agent contains less than about 5 wt % water, more preferably less than about 1 wt % water, even more preferably, less than about 100 ppmw water, even further preferably less than about 10 ppmw water and still further, preferably less than about 1 ppmw water. In another embodiment, the treating agent is substantially absent water. The levels of sanitizing agents contained in the treating agent are only limited by the ability of one to form a mixture of the particular cooling agent and sanitizing agent.

The treating agent of the current invention is transportable. Thus, a treating agent containing the sanitizing agent, including unstable sanitizing agents such as ozone, can be delivered to site for use in many different processes. This avoids the need for the user to purchase special equipment to produce or mix sanitizing chemicals at site. Of particular interest, is the elimination of ozone generating equipment, which can be expensive, and can involve safety concerns for handling reactive chemicals, such as pure liquid oxygen. The treating agent of the current invention can be transported in solid form in refrigerated trucks, or in liquid form in cylinders, tanks, or tank trucks, thus eliminating the need for the user to generate ozone at site.

As used herein, the phrase “target item” refers to equipment, utensils, devices, food products, pharmaceutical products, medical devices, medical specimens, liquids, water, or other items that are in need of safe transportation, sanitation, preservation, or otherwise protecting from or treated for biological microorganisms, particularly pathogenic microorganisms.

As used herein, the phrase “food or food product” generally refers to all types of foods, including, but not limited to, meats, poultry, seafood, produce, dry pasta, breads and cereals and snack foods. The food may be in solid or liquid form, such as water, juice, soups, beverages, or other items. The current inventive method may be used in conjunction with any food that is able to support microbial, i.e. fungal, bacterial or viral growth, including unprocessed or processed foods.

As used herein, the term “biocidal agent” or “sanitizing agent” generally refers to any substance known to one of ordinary skill in the art that when contacted with the target item reduces the number of biological microorganisms, particularly pathogenic microorganisms, on or in the target item, or reduces the growth rate of the biological microorganisms on or in the same.

The terms “sanitize” and “treat”, as well as variations thereof, generally mean the reduction of the microbial and/or spore content. The terms “substantially sanitize” and “substantially disinfect” refer to the attainment of a level of microorganisms and/or spores such that the target item is safe to use, or safe for consumption by a mammal, particularly by humans. Generally, as used herein, sanitizing refers to the elimination of at least about 90.0 to 99.9% of all microorganisms and/or spores, including pathogenic microorganisms, in or on target items. Preferably, at least about 90.0 to 99.99%, and more preferably at least about 90.0 to 99.999% of such microorganisms and/or spores, are eliminated.

The sanitizing agent of the current invention can be any biocidal agent known to one skilled in the art that is effective in reducing the number of biological microorganisms, particularly pathogenic microorganisms, on or in the target item, or reduces the growth rate of the biological microorganisms on or in the same. The sanitizing agent can be in gas, liquid, or solid form before or when combined with the cooling agent.

Preferred sanitizing agents include, but are not limited to, ozone, chlorine dioxide, hydrogen peroxide, chlorine, and mixtures thereof. The quantity of sanitizing agent present in the treating agent varies with varying sanitizing agents and cooling agents, but preferably is in the range of 1 ppmw to about 10% by weight (wt %). The quantity can be any quantity that supplies the desired concentration of sanitizing agent to the target item as the cooling agent vaporizes, sublimes, or mixes with the target item. In one embodiment, the treating agent is in solid form, the sanitizing agent is ozone, and the treating agent contains greater than about 1 ppmw ozone, preferably greater than about 2 ppmw, more preferably greater than about 5 ppmw ozone, even more preferably between about 5 to 100 ppmw of ozone, and even further preferably between about 1 to 20 ppmw. In another embodiment, the treating agent is in liquid form, and contains greater than about 50 ppmw ozone, and more preferably greater than about 200 ppmw ozone. In another embodiment, the sanitizing agent is chlorine dioxide, hydrogen peroxide, chlorine, or mixtures thereof, and the treating agent contains between about 0.01 to about 10 wt % sanitizing agent.

Sanitizing agent may be mixed with the cooling agent in a pure form, such as a pure gas, or as a mixture with a delivery agent, for instance a solid in a solvent. The sanitizing agent can be mixed with any suitable solvent, diluent, or delivery material when combined with the cooling agent to form the treating agent. In one preferred embodiment, the solvent, diluent, delivery material or mixture containing the sanitizing agent is substantially absent water.

The sanitizing agent can be homogeneously or non-homogeneously dispersed throughout or contained in the treating agent. Furthermore, the release of the sanitizing agent, or sanitizing action of the treating agent, can be uniform, or can be non-uniform. That is, the sanitizing action of the treating agent may occur in a burst, or multiple bursts, or may be very uniform over time as the cooling agent sublimes or vaporizes.

The treating agent of the current invention is also self-sanitizing. Through environmental monitoring and testing of cooling agents, it has been determined that some cooling agents, particularly dry ice, may become contaminated by exposure to the atmosphere, through handling by humans, or by contact with contaminated equipment. While not being bound by any particular theory, it is believed that in one contaminating mechanism, moisture and other contaminants will condense in and on the cooling agent when the cooling agent is exposed to air. The condensing materials can be or can carry with them biological contaminants that contain pathogenic microorganisms. Furthermore, some equipment transferring and storing cooling agents may contain pathogenic microorganisms that are transferred to the cooling agent during transfer. Thus, some cooling agents, particularly dry ice, are contaminated with pathogenic microorganisms during storage and handling. The pathogenic microorganisms may be transferred to the target item when the target item is exposed to the cooling agent or treating agent. The treating agent of the current invention contains a sanitizing agent. Thus, any biological microorganisms, particularly pathogenic microorganisms, that are in or on the cooling agent, or that are transferred to the treating agent during handling, are neutralized by the sanitizing agent either immediately, or when the treating agent warms. Thus, the treating agent is a self-sanitizing treating agent.

The cooling agent of the current invention can be any cooling agent known to one of ordinary skill in the art that is suitable for use in or on target items, or processing systems. As used herein, the cooling agent may, but does not necessarily, cool the target item, maintain the temperature of the target item, or otherwise affect the temperature of the target item. In some embodiments, the temperature of the target item may be greatly affected by the cooling agent, and in others, the cooling agent may have little to no effect on the temperature of the target item. It is also possible that the cooling agent may in fact freeze the target item. “Cooling” a target item refers to changing the thermal state of an object, including changing the temperature or freezing the object. The cooling agent can be in solid or liquid form. One preferred cooling agent is non-aqueous. Preferred cooling agents are liquefied gases, solids made from liquefied gases, or mixtures thereof. As used herein, the term “liquefied gases” includes single component liquefied gases, or mixtures of liquefied gases. As used herein, the term “solid” includes single component solids, or mixtures of solids. In one embodiment, the preferred cooling agent is substantially absent water. In the context of a cooling agent, substantially absent water means there is essentially no water present except for low levels of moisture that may be present due to contamination of the cooling agent or equipment. In another preferred embodiment, the cooling agent comprises less than about 1 wt % water, more preferably less than about 1,000 ppm water, and even more preferably less than about 10 ppmw water. Preferred cooling agents include carbon dioxide (CO₂), nitrogen (N₂), or other liquefied gases known to one of ordinary skill in the art. Some liquefied gases, such as carbon dioxide, can be converted to a solid form (solid CO₂ is commonly referred to as “dry ice”) by processes well known in the industry and used as a cooling agent of the current invention. The cooling agents of the current invention convert from a solid or liquid form into a vapor form when exposed to a heat source.

One embodiment of the current invention provides a method of processing a target item that exposes the target item to a treating agent that contains a sanitizing agent and a cooling agent. The treating agent is preferably in a solid form or liquid form before or when initially exposed to the target item. The sanitizing agent remains present in the treating agent while the treating agent is in its solid form or in a liquid form under pressure. For the solid form, as heat is absorbed by the treating agent, the cooling agent converts to a vapor by sublimation. For the liquid form, the liquid converts to a vapor as the pressure is dropped, and/or as heat is absorbed by the treating agent. While not being bound by any particular theory, it is believed that upon conversion into a vapor, the cooling agent releases the sanitizing agent, or transports the sanitizing agent to the target item. Once released or transported, the sanitizing agent contacts the target item, or microorganisms in or on the target item, thus providing a sanitizing action. In another preferred emobiment, the sanitizing agent stays in the liquid, and the liquid/sanitizing agent mixture contacts the microorganisms in and on the target item providing the sanitizing action. One preferred embodiment of the current invention contains at least 90% by weight cooling agent.

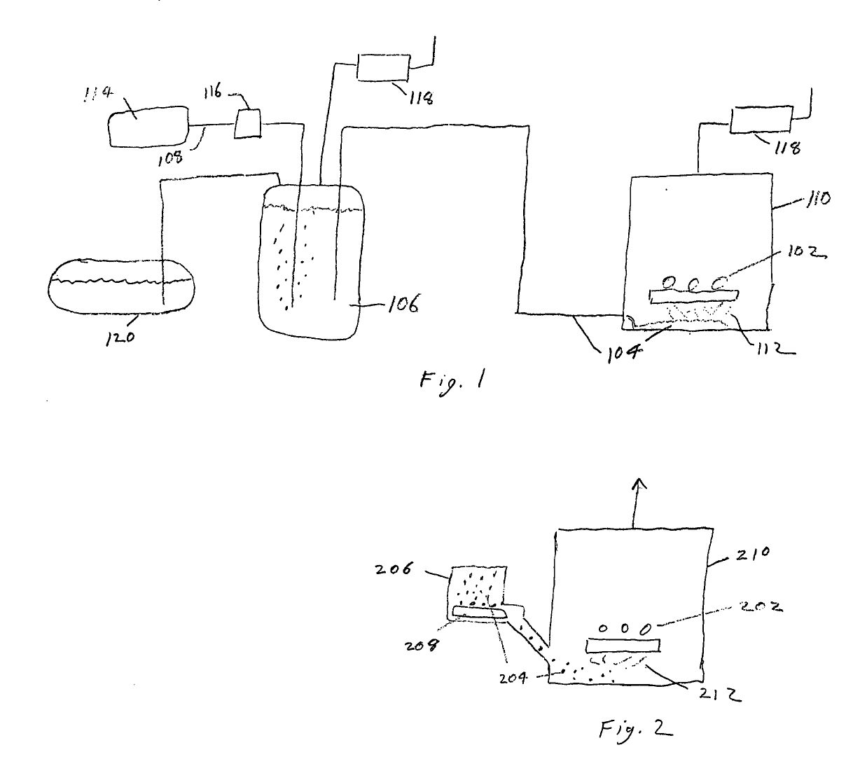

Referring to FIG. 1, one example of the current invention exposes a target item 102 to a liquid treating agent 104. The liquid treating agent is formed by combining a liquid form cooling agent from a storage tank 120 with a gaseous form sanitizing agent. The gaseous sanitizing agent, ozone in this example, is produced in an ozone unit 114, compressed in a compression system combined with a liquid cooling agent 106 by bubbling the gaseous sanitizing agent 108 through the liquid cooling agent 106. A solid sanitizing agent (not shown) can be combined with a liquid cooling agent by dissolving or suspending the sanitizing agent in the cooling agent, or in another suitable diluent before being combined with the cooling agent. The liquid treating agent 104 is fed directly to a treatment area 110 to expose a target item 102 to the treating agent 104. As the liquid treating agent 104 vaporizes, vapors of the cooling agent and/or sanitizing agent 112 contact the target item 102 to cool and or/treat the target item. Ozone destruct units 118 may be required to destroy ozone containing gases coming from various equipment in the system. The liquid treating agent can also be used to sanitize the inside of equipment and piping of various systems handling food, pharmaceutical, or medical products (not shown). Furthermore, the liquid treating agent can be used to produce a solid form of the treating agent, such as an ozonated dry ice embodiment described herein.

Referring to FIG. 2, one aspect of the current invention exposes a target item 202 to a solid treating agent 204. The solid treating agent is fed from a hopper 206 via a controlled feeding device 208 to a treatment area 210 to expose a target item 202 to the treating agent 204. As the solid treating agent 204 sublimes, vapors 212 from the cooling agent and/or sanitizing agents contact the target item 202 to cool and or/treat the target item. Treating units (not shown), such as ozone destruct units, may be required to destroy gases coming from the system. However, a preferred embodiment does not require a treating unit because the levels of sanitizing agent do not require such a device.

The treating agent can be used to treat a target item while in most any type of package, and treatment area, or device. As used herein, “package” is meant to have a broad meaning, including, but not limited to, any enclosure, vessel, container, bag, wrapper, tray, or other device enclosing a target item. Examples for treatment areas that process food products include, but are not limited to, a tunnel, tumbler, blender, plate, chamber, vessels, storage containers, transport containers, and combinations of these devices. One preferred embodiment captures and recycles the cooling agent.

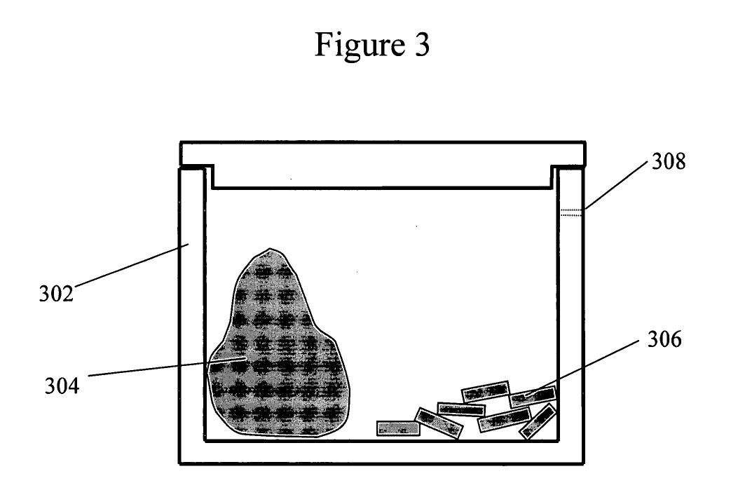

In one aspect of the current invention, a packaged product comprising a target item and a treating agent is provided. Referring to FIG. 3, the method places a target item 304 into a package 302 and adds a solid treating agent 306 described above to the package. The cooling agent contained in the treating agent vaporizes or sublimes to cool or maintain the temperature in the package, and thus the target item, while also contacting the target item and package interior with the sanitizing agent. Some packages may be sealed, and thus may require a vent port 308 to vent the gases as the treating agent 306 sublimes. In one embodiment, the food is packaged for sale or distribution with the treating agent placed in the package. The treating agent may be in direct contact with the target item, or may be separated from the food by packaging material, or in a separate compartment of the package.

Preferred methods of processing a target item according to the current invention may also expose the target item to a UV device. Exposing the target item to a UV device during or after the target item is exposed to the sanitizing agent will improve effectiveness of the sanitizing method.

In one embodiment of the current invention, the pH of the target item, particularly water, is adjusted with the addition of the treating agent. The pH of the target item may be regulated by regulating the exposure of the treating agent to the target item. In this embodiment, the cooling agent preferably provides the pH adjustment, and may provide some treating action, while the sanitizing agent simultaneously treats the target item for biological microorganisms. A particularly preferred cooling agent for this embodiment is CO₂.

One preferred embodiment of the treating agent comprises a liquid form treating agent containing ozone. The ozonated liquid treating agent is formed by combining a cooling agent and a compressed ozone-containing feed mixture. However, conventional compression systems are not preferred for compressing ozone-containing mixtures. Mechanical compression causes the ozone in the mixture to break down on contact with hot compressor parts or as the mixture heats up under the compression process. Liquid ring compression techniques are not preferred because the compressed ozone is contaminated with water, resulting in contamination of the treating agent and freezing of the water before the treating agent is formed. Furthermore, liquid ring compression is typically limited to a maximum pressure attainable of about 150 psig. Thus, to provide a compressed ozone-containing feed mixture, applicants developed a novel dry gas compression system, described herein, to compress an ozone-containing feed mixture.

The dry gas compression system described below can be used to safely compress a gaseous sanitizing agent feed mixture containing a sanitizing agent, particularly unstable agents such as ozone, without destroying the sanitizing agent, and without contaminating the sanitizing agent with oil, or water. In one exemplary embodiment, a sanitizing agent feed mixture is compressed to a pressure of greater than about 30 psig. Other preferred embodiments compress a sanitizing agent feed mixture to a pressure of greater than about 90 psig. Still other embodiments may compress a sanitizing agent feed mixture to greater than 150 psig. Other pressures are possible as required by the process. It is feasible to safely compress an ozone/oxygen sanitizing mixture containing 10% by weight of ozone to at least about 1000 psig pressure using dry gas compression.

The novel dry gas compression system has a plurality of pressure vessels arranged in series. The size and number of the tanks depends on the volume of ozone required and the final pressure required. A preferred gas compression system has at least two tanks, and a more preferred gas compression system has at least three tanks. In one example embodiment, the compression system comprises five tanks. The first four tanks are five gallons in volume, and the fifth tank has a ten gallon volume. The gas inlet tube of each tank is a dip tube from the top to the bottom of the tank. The gas outlet tube on each tank comes from the top and feeds the dip tube of the next tank in the series.

The operation of a dry gas compression system will now be described in the non-limiting context of compressing an ozone-containing stream. For this example, ozone is generated in a commercial ozone generation unit, typically using a pure oxygen feed, to form an ozone-containing feed mixture. The ozone-containing feed mixture preferably contains about 6 to 13 wt % ozone in oxygen, and more preferably about 9 to 11 wt % ozone. The ozone-containing feed mixture is placed in the system of tanks, where it is compressed using a dry gas, such as CO₂. In this context, dry gas refers to a gas that is substantially absent water. To start, the tanks are purged with the ozone-containing feed mixture to establish a uniform concentration of ozone in all tanks. Then, the series of tanks are pressurized with the ozone-containing feed mixture to set an initial pressure, for instance about 5 to 25 psig, in all tanks. The higher the initial pressure in the compression system, the higher final pressure that can be achieved. The tanks are then isolated from the ozone generator. Next, dry gas is fed through a dip tube to the first tank to push the ozone-containing feed gas from the first tank to the successive tanks and raise the pressure in the tanks. The dry gas is added slowly to minimize mixing of the dry gas with the ozone mixture. As the dry gas enters the first tank, the ozone-containing feed mixture is pushed to the successive tanks, followed by the dry gas, successively displacing the ozone-containing feed mixture and filling successive tanks with dry gas. Again, it is primarily the ozone-containing mixture that is first pushed to the successive tanks. It is believed that if the density of the dry gas and the ozone-containing feed mixture is substantially different, the gas stratifies in the tanks and mixing is minimal. The final result is a compressed ozone-containing feed mixture typically containing close to, but somewhat lower concentration of ozone in oxygen that the ozone-containing feed mixture. The dry gas feed to the tanks is stopped when the desired pressure in the last tank is reached. The compressed ozone-containing feed mixture is typically fed to the process from the last tank. The last tank is isolated from the prior tanks to prevent unwanted dilution of the pressurized ozone mixture. The pressure from the last tank is allowed to drop as the ozone-containing feed mixture is fed to the process.

If a continuous operation of pressurized ozone feed is desired, then tanks upstream of the last tank must be replenished with pressurized ozone. To accomplish this, the tanks upstream of the last tank may be vented of their pressure, purged, re-filled with the ozone-containing feed gas, and pressurized as described above. This new batch of pressurized gas may then be released into the last tank. This re-filling gives a slightly more dilute ozone mixture. A more efficient arrangement consists of several sets of tanks, operated in a “round robin” to maximize the use of the ozone generator, capture all pressurized ozone that does not reach the last tank, and minimize the waste of dry gas by cross-tying the sets of tanks. The dry gas can be any suitable non-aqueous gas, but is preferably a liquefied gas, particularly a liquefied gas with a high gas density compared to the ozone-containing feed mixture.

If inert gases other than the gas of the cooling agent are used for ozone compression or included with the ozone during injection, the resulting feed of the treatment agent may comprise some amounts of those inert gases. It is preferred that the inert concentration in the treating agent that is fed to a treatment process not exceed about 10% by weight.

The current invention will now be further described in terms of a non-limiting embodiment of the current invention that uses solid CO₂ (“dry ice”) as the cooling agent and ozone as the sanitizing agent. The dry ice product can be manufactured in the form of blocks, pellets, flakes, powders, and other possible forms containing carbon dioxide and ozone. The dry ice product is essentially free of, or substantially absent water. In the context of a treating agent using dry ice as the cooling agent, what is meant by “essentially free of” or “substantially absent” water is that the dry ice product will comprise less than about 5 wt % water. More preferably, the water content will be less than 1 wt %. Moisture levels of up to 5,000 ppmw may be helpful in maintaining the desired shape of the product. The major constituent of the dry ice based treating agent is carbon dioxide. In other preferred embodiments, the dry ice product contains less than about 100 ppmw water, more preferably, less than about 10 ppmw water and still more preferably less than about 1 ppmw water. The dry ice may contain binding agents other than water, such as propylene glycol or ethanol. The ozone concentration in the treating agent can vary widely and can depend upon the end use of the product and, in particular, the product being treated and the environment surrounding the treated product. Only minute amounts of ozone are required to contact the target item to provide an antimicrobial effect. Furthermore, OSHA limits the exposure levels of ozone to humans at 0.1 ppm to 0.3 ppm in 8 hour and 15 minute shifts, respectively. Accordingly, the amounts of ozone dispersed into an area must be kept at a minimum and to a level safe for persons handling the treated product. A non-limiting level of ozone in the dry ice product can range from 0.1 ppm and above. The ozone content of the dry ice product will preferably range from about 1 to 1,000 ppm, more preferably range from about 1 to 100 ppm, and even more preferably range from about 1 to 20 ppm. Ozone levels in the environment in contact with the target item of 1 to 10 ppm by weight are believed to be effective for killing bacteria.

Preferred treating agents of the ozonated dry ice embodiment provide an expendable form of refrigeration while simultaneously providing a method of biological treatment that does not expose humans coming in contact with the target item to excessive levels of ozone. Ozone gas is generally considered to be an unstable molecule that has a short shelf life. It is known that at lower temperatures ozone is more stable, and has a reduced tendency to decompose to oxygen prior to providing any biological effect. Dry ice at atmospheric pressure is at a temperature of about −110° F. The liquefaction temperature of ozone is about −168° F. This means that the ozone contained in the dry ice product is close to the liquefaction point, but still well into the gas phase. Accordingly, it is believed that the ozone mixed with dry ice can be trapped in the structural lattices of the dry ice and/or physically absorbed into the dry ice. In one preferred embodiment, the most effective biocidal treatment is believed to occur when the ozone is released in proportion with the dry ice sublimation.

The exact form of the treating agent can vary and, accordingly, a wide variety of forms can be manufactured and used depending upon the target item to be treated and the purpose of such treatment such as, for example, storage, transport, or commercial sale display of food products. If the target item is stored in large rooms, blocks of dry ice ranging from 5 to 50 lbs. can be used. Likewise, if the target item to be stored, transported, or displayed for sale requires direct contact of the dry ice product, smaller manufactured shapes can be provided. For example, pellets in the range of 1/16 to 1 inch or even larger can be formed, or even powders such as snow, flakes, or chips can be formed by methods known in the art.

In the ozonated dry ice embodiment, it has been found to be particularly useful to incorporate the ozone into the carbon dioxide during the dry ice manufacturing process. The traditional first step in making dry ice is to manufacture carbon dioxide liquid. This is done by compressing CO₂ gas and removing any excess heat. The CO₂ is typically liquefied at pressures ranging from 200-300 psig and at a temperature of −20° F. to 0° F. respectively. It is typically stored in a pressure vessel at lower than ambient temperature. The liquid pressure is then reduced below the triple point pressure of 69.9 psig by sending it through an expansion valve. This can be done in a single step or, in many cases, by reducing the liquid pressure to 100 psig at a temperature of −50° F. as a first step to allow easy recovery of the flash gases followed by a second reduction to below the triple point to form solid CO₂. The liquid CO₂ is expanded inside a dry ice manufacturing press to form a mixture of dry ice solid and cold gas. The cold gas is vented or recycled and the remaining dry ice snow is then compacted to form blocks. Dry ice is typically compacted to a density of approximately 90 lb/ft³. However, various embodiments may use any density appropriate for the application.

One method of forming ozonated dry ice feeds compressed ozone into the liquefied carbon dioxide stream feeding the ice press used to form ozonated dry ice. Another embodiment feeds liquefied carbon dioxide that has ozone absorbed into the liquid (“ozonated liquefied CO₂”) as described above, which is fed to the ice press to form ozonated dry ice. Yet another embodiment feeds liquefied carbon dioxide and compressed ozone to an ice press as separate streams, which then combine in the press to generate dry ice “snow” containing ozone, and oxygen. Using any of the methods above, the ozonated dry ice can then be collected or shaped such as by pressing or extrusion. These schemes can be easily adapted to existing dry ice plants.

In comparison, the prior art dwells in using indirect methods to combine ozone with dry ice after the dry ice is manufactured. This limitation of the prior art was largely because of the difficulty of compressing ozone safely and without contaminating the ozone. Ozone production units typically produce an ozone-containing stream at pressures of between 5 and 25 psig. If higher ozone-containing stream pressures are required, the stream can be compressed to 150 psig using water ring compression. However, compressing by water ring compressions results in ozone contaminated with water. The contaminated ozone is mixed with other streams, such as a liquid CO₂, results in a water-contaminated mixture. Thus, any ozone-containing products of the prior art that are produced using a compressed ozone-containing stream will inherently contain some amount of water. When the contaminated liquid CO₂/ozone mixture expands in the treatment device or the ice press, the water contaminant then freezes, plugging the CO₂ injection point or causing other undesirable effects. As indicated above, applicants use a method of dry compression to safely compressing ozone without contaminating or destroying the ozone. Thus, the compressed ozone-containing feed mixture of the current invention is free of any water. Having an ozone source that is free of water allows the treating agent to be produced that is free of water.

Methods of producing ozone are well known in the art. Ozone generation modules are commercially available that use a feed gas of O₂, air, a mixture of O₂ and air, or mixtures of O₂, air, and an inert gas, e.g. N₂, CO₂, Ar, Kr, Xe, or Ne. There are two primary methods of creating ozone from air: by an ultraviolet light generator light system or by an electrical discharge system. An ultraviolet light ozone generator typically consists of multiple ultraviolet light tubes within an aluminum housing. In a multiple tube apparatus, air enters the generator cavity and is subjected to the ultraviolet light and the ultraviolet light causes a disassociation of the oxygen molecules, which exists as O₂, to two oxygen atoms. Some of these oxygen atoms attach themselves to oxygen molecules to form ozone (O₃). The resulting ozone and sterile air mixture comprises approximately 0.2 percent of ozone by weight/weight of air. In one preferred mode, the ozone gas is generated from oxygen or oxygen-enriched air by a corona discharge device that produces concentrations ranging between about 1% to about 15% by weight of ozone. It is possible to use higher ozone concentrations for this application if the generator technology becomes available. Higher concentrations of ozone are preferred. It is preferred to use oxygen compared to air due to the possibility of producing higher concentrations of ozone.

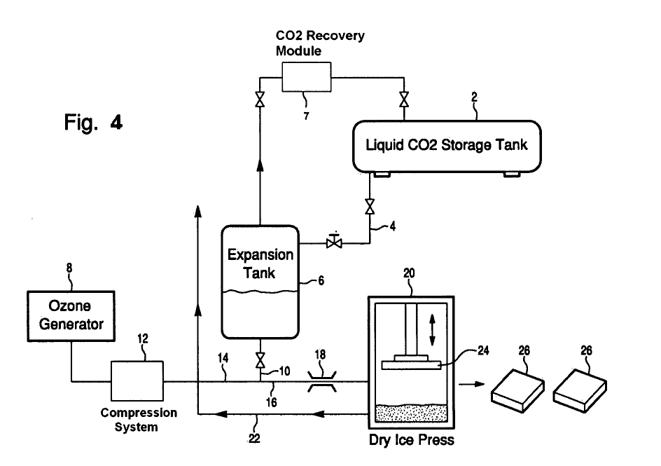

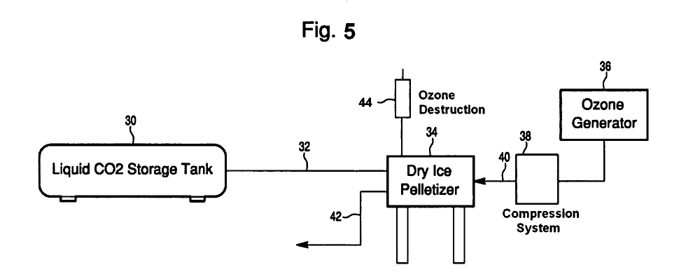

FIGS. 4 and 5 depict representative methods of forming a treating agent of ozonated dry ice. FIG. 4 is a process used to form blocks of dry ice, while FIG. 5 depicts a process used to form dry ice pellets. These processes can be modified to incorporate sanitizing agents, such as ozone, into the dry ice product. First, with respect to FIG. 4, liquid carbon dioxide is stored in a storage tank 2, typically at pressures of 200 to 300 psig. The liquid carbon dioxide from the storage tank 2 is then passed via a line 4 to a low-pressure expansion tank 6 wherein the liquid CO₂ is expanded to a pressure above the triple point of carbon dioxide (69.9 psig). Typically, the liquid CO₂ is expanded to pressures of from about 70 to 100 psig in the expansion tank 6. What results is a mixture of gas and a dense, viscous carbon dioxide liquid. It is important that the liquid CO₂ is not formed into solid dry ice at this point in as much as the solid in the piping would disadvantageously reduce transport of the liquid. Ozone from an ozone generator 8 is then injected into the liquid carbon dioxide. Injection of the ozone can be done in the low-pressure expansion tank although, as shown in FIG. 4, the ozone is mixed with the liquid CO₂ after the liquid CO₂ leaves the expansion tank 6. In one embodiment, the expansion tank is held at less than about 75 psig during ozone injection. Ozone from the ozone generator 8 is compressed to pressures of from about 100 to 150 psig in a compression system 12 and then mixed with the liquid CO₂. The mixture of ozone and liquid CO₂ is passed through an expansion orifice 18 into the dry ice press 20. Alternatively, although not shown, the mixture of ozone and liquid CO₂ can be passed to a separate refrigeration unit, wherein the liquid CO₂ is frozen into a solid containing the ozone. Another alternative not shown is feeding a liquid CO₂ containing the ozone wherein the ozone is bubble up through the liquid as described above to form an ozonated liquid CO₂.

As further shown in FIG. 4, the mixture of liquid CO₂ and ozone is allowed to expand inside the dry ice press 20. During expansion, the liquid CO₂ is converted to a solid form and the ozone is trapped in the structural lattices of dry ice or physically absorbed during dry ice formation. The major portion of the ozone will remain attached to the cold dry ice particles and only a small portion will exit the dry ice press 20 with the flash gases. Once the dry ice solid is formed, the solid particles can be compressed via a platen 24 in a press 20 into ozonated dry ice blocks 26.

The sanitizing agent in the treating agent necessary for biological treatment is released or transported to the target item as the cooling agent sublimes or vaporizes during use. Higher concentrations and pressures of sanitizing agent are preferred to achieve higher concentrations of sanitizing agent in the treating agent. The preferred concentration of sanitizing agent can vary depending upon the use of the treating agent and the target item treated. By applying the above method to the ozonated dry ice example product, it is possible to achieve higher concentrations of ozone compared to the prior art methods, which have involved a mixture of ozonated water ice and dry ice.

Referring now to FIG. 5, which depicts a process used to form dry ice pellets, such process is similar to that shown in FIG. 4. With respect to FIG. 5, liquid carbon dioxide is stored in a tank 30, again, typically at pressures of 200 to 300 psig. The liquid carbon dioxide from the storage tank 30 is then passed directly to a dry ice pelletizer 34. Dry ice pelletizers are well known in the art. It is believed any dry ice pelletizer is capable of use with this invention. In the pelletizer, the liquid CO₂ is expanded to a pressure below 70 psig. What results is a mixture of gas and carbon dioxide solid particles. Ozone from the ozone generator 36 is compressed to pressures of about 100 psig to about 150 psig, and more preferably to greater than 150 psig, in the compression system 38 and then mixed with the CO₂ in the dry ice pelletizer 34.

The liquid CO₂ is allowed to expand inside the dry ice pelletizer 34 and is converted to a solid form. While not wanting to be bound by any theory of operation, if the ozone is added during expansion, it is believed that the ozone is trapped in the structural lattices of dry ice. A major portion of the ozone will remain attached to the cold dry ice particles and only a small portion will exit with the flash gases from the pelletizer 34 via line 42. The solid CO₂ particles are extruded into pellets, typically ranging from 1/16 to 1 in. As in the block dry ice, the ozone in dry ice pellets necessary for biological treatment is released in a controlled manner as the carbon dioxide sublimes during use. In one preferred embodiment of ozonated dry ice, the ozone is released evenly in proportion to the rate the dry ice sublimes.

Small amounts of adjuvants may be added into the treating agent to improve the stability of the sanitizing agent in the treating agent. Non-limiting useful adjuvants are as follows:
a) Water (not to exceed 5 wt % of dry ice);
b) GRAS (generally recognized as safe) grade acidulants such as citric acid, acetic acid, lactic acid;
c) GRAS grade surfactants such as polysorbate 60/65/80;
d) GRAS grade food preservatives such as EDTA (in any forms), BHA, BHT, sodium nitrate (in any forms);
e) GRAS gums such as carrageenan (in any forms), xanthan gum, furcelleran (in any forms), arabinogalactan; and
f) Any other GRAS grade food additives such as polyethylene glycol, sucrose fatty acid esters, fatty acids (in any forms).

The sanitizing agent of this invention improves the biocidal efficacy of cooling agents, such as dry ice, to better ensure safe target items, such as safe food products. The sanitizing agent is effectively delivered into the cooling agent, such as dry ice, at a desired concentration such that during sublimation or vaporizing of the cooling agent, the sanitizing agent contacts the target item and exerts the desired biocidal effect for disinfection and/or sanitation purposes. The sanitizing agent is released or transported to disinfect target items, and to ensure significant reductions of biological microorganisms. Because sanitizing agents are often more stable under cold environments, the process provides the favorable conditions for sanitizing agents to work at maximum efficiency. Since the release of the sanitizing agent from the cooling agent can be regulated, the rate the target items receive sanitizing agent can be regulated as desired during the entire storage, transportation, or processing thereof. Accordingly, shelf life and quality of the target item is enhanced. Moreover, the cooling agent chills the target items efficiently, further providing benefits to target item. The cooling agent slows down the growth of biological microorganisms, particularly pathogenic microorganisms that lead to spoilage in food, allowing food products to last longer and be safer. The cooling agent also slows down the enzymatic reactions in food, allowing the quality of food to be extended during storage. A cooling agent using sublimation or vaporization also allows the cooling agent, particularly carbon dioxide, to penetrate into microbial cells. Carbon dioxide is known to lower the intracellular pH of microbial cells, and cause those microbial cells to be more sensitive to the sanitizing agent. Accordingly, a synergistic effect on biocidal efficacy can be achieved by combining a cooling agent, such as dry ice, and a sanitizing agent, such as ozone.

### EXAMPLE 1

The following example illustrates the formation of a solid treating agent of the current invention comprising ozonated dry ice snow. A reactor vessel was supplied to contain liquid CO₂. The reactor was purged with gaseous CO₂ from the supply vessel. The reactor was pressure adjusted to maintain 100 psig in the reactor.

Liquid CO₂ was directed from the supply vessel to the reactor and the flow adjusted. The pressure in the reactor was kept at 100-120 psig. When the reactor was 66% to 75% full of liquid, liquid CO₂ flow to the reactor was stopped.

A gaseous ozone line was connected to the inlet of the reactor. The ozone was produced from oxygen using an Ozonia® ozone generator CFS-2 (Ozonia® Ltd., Switzerland). The ozone was collected and then compressed to a pressure of about 150 psig using dry gas compression. The pressure of the ozone system was maintained higher than the pressure of the reactor. The ozone gas was slowly opened to adjust the flow rate of ozone into the reactor. The pressure in the reactor was maintained such that reactor pressure did not increase by more than about 5 psig. After the desired amount of ozone had been sent to the reactor or when the pressure of the ozone system approached the pressure of the reactor, the ozone inlet was closed.

The ozone-containing dry ice “snow” was directed from the bottom of the reactor into an insulated container until enough snow had been produced.

CO₂/O₃ snow was collected and placed into a beaker. KI solution was added. The snow was allowed to completely sublime while the KI solution was constantly washed over the snow. The solution was titrated with 0.1 N Na₂S₂O₃. This procedure followed the iodometric method of determining the amount of ozone present in the sample.

A first test run of the laboratory scale system described above produced about 4 to 5 kg of ozonated snow. The amount of liquid carbon dioxide in the reactor was about 9 L. Approximately 2 liters of compressed gas was transferred into the liquid CO₂. The gas contained about 6.5% (wt/wt) 03 in O₂ with a gas pressure of about 118 psig. The snow that was produced during this test had an ozone concentration of about 2 ppm.

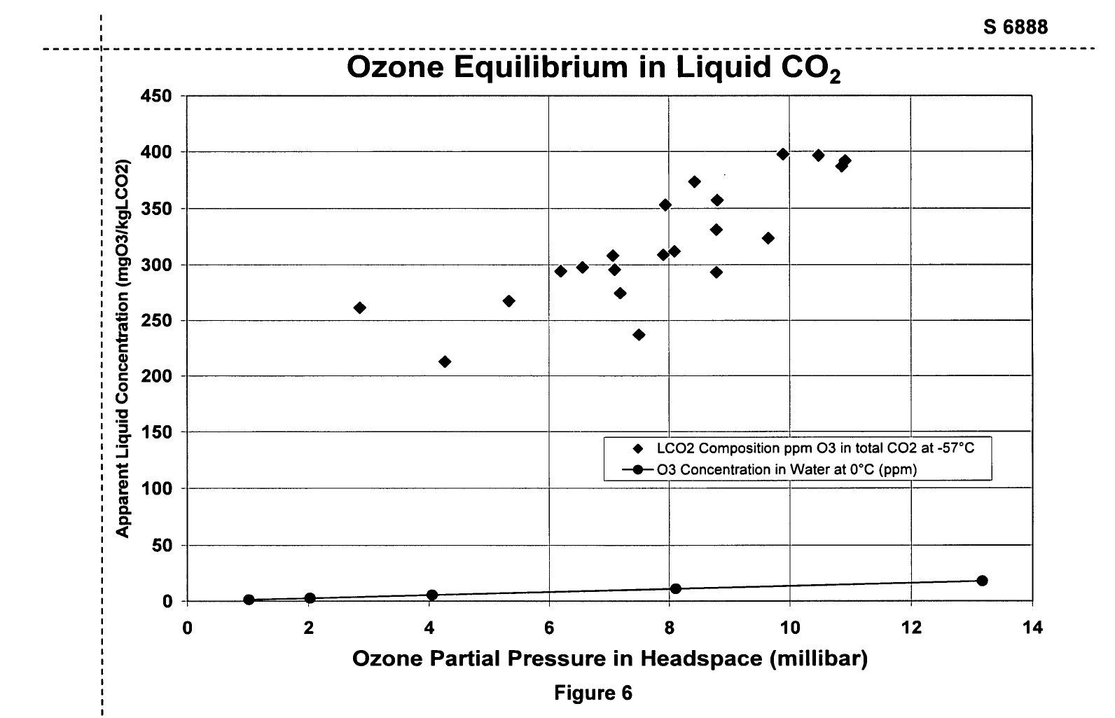

A liquid form treating agent was produced using liquid CO₂ and ozone-containing feed mixture compressed using a dry gas compression system. The liquid treating agent was formed by bubbling the compressed ozone-containing feed mixture through a tank of liquid CO₂. The liquid CO₂ was held in a tank at a pressure above the triple point of CO₂ (70 psig) while the compressed ozone-containing feed mixture was bubbled up through the liquid CO₂. Tank pressures of about 70 psig to 120 psig, and preferably between 70 and 75 psig, were used during the combining process. Compression of the ozone-containing feed mixture to a pressure of at least about 5 psi above the CO₂ pressure was required to feed the ozone-containing feed mixture into the CO₂. As is shown in FIG. 6, concentrations of between about 200 and about 400 ppmw (apparent concentration based on mass balance and headspace analysis) ozone in liquid CO₂ were demonstrated.

Although the present invention has been described in considerable detail with reference to certain preferred versions and examples thereof, other versions are possible. For instance, although specific sanitizing agents are named, any suitable sanitizing agent may be used in the method. Furthermore, the current invention may be used in a variety of processes for processing food, or non-food items. Therefore, the spirit and scope of the appended claims should not be limited to the description of the preferred versions contained herein.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A treating agent comprising a cooling agent and a sanitizing agent, wherein:
a) said cooling agent is selected from the group consisting of a liquefied gas, a solid made from a liquefied gas, and mixtures thereof;
b) said treating agent is in a form selected from the group consisting of a solid form, a liquid form, or combinations thereof when initially exposed to said target item; and
c) said treating agent is substantially absent water.

2. The treating agent of claim 1, wherein said cooling agent is in solid form, and wherein said cooling agent converts to a gaseous form as heat is absorbed by said treating agent.

3. The treating agent of claim 1, wherein said cooling agent is selected from the group consisting of N₂, CO₂, and mixtures thereof.

4. The treating agent of claim 1, wherein said sanitizing agent is selected from the group consisting of ozone, chlorine dioxide, hydrogen peroxide, chlorine, and mixtures thereof.

5. The treating agent of claim 1, wherein said cooling agent is selected from the group consisting of N₂, CO₂, and mixtures thereof, and wherein said sanitizing agent is selected from the group consisting of:
a) ozone;
b) chlorine dioxide;
c) hydrogen peroxide;
d) chlorine;
e) and mixtures thereof.

6. The treating agent of claim 1, wherein a concentration of said sanitizing agent in said treating agent is greater than about 1 ppm by weight.

7. The treating agent of claim 6, wherein said concentration of said sanitizing agent is greater than about 2 ppm by weight.

8. The treating agent of claim 1, wherein said sanitizing agent comprises ozone, and wherein a concentration of said ozone in said treating agent is about 1 to 20 ppm by weight.

9. The treating agent of claim 1, wherein said sanitizing agent comprises ozone, and wherein a concentration of said ozone in said treating agent is greater than about 20 ppm by weight.

10. The treating agent of claim 1, wherein said treating agent is in a liquid form, wherein said sanitizing agent comprises ozone, and wherein a concentration of said ozone in said treating agent is greater than about 50 ppm by weight.

11. The treating agent of claim 10, wherein said cooling agent comprises liquefied CO₂.

12. The treating agent of claim 1, wherein said treating agent comprises at least about 0.01 wt % said sanitizing agent and sanitizing agent is selected from the group consisting of:
a) chlorine dioxide;
b) hydrogen peroxide;
c) chlorine; and
d) mixtures thereof.

13. The treating agent of claim 1, wherein said sanitizing agent substantially sanitizes said cooling agent.

14. A packed item comprising:
a) a package;
b) a target item; and
c) a treating agent, wherein:
i) said treating agent comprises a sanitizing agent and a cooling agent;
ii) said cooling agent is selected from the group consisting of a liquefied gas, a solid made from a liquefied gas, and mixtures thereof;
iii) said treating agent is in a form selected from the group consisting of a solid form, a liquid form, or combinations thereof when initially exposed to said target item; and
iv) said treating agent is substantially absent water.

15. The packaged item of claim 14, wherein said cooling agent is in solid form, and wherein said cooling agent converts to a gaseous form as heat is absorbed by said treating agent.

16. The packaged item of claim 14, wherein said cooling agent is selected from the group consisting of N₂, CO₂, and mixtures thereof.

17. The packaged item of claim 14, wherein said sanitizing agent is selected from the group consisting of:
a) ozone;
b) chlorine dioxide;
c) hydrogen peroxide;
d) chlorine; and
e) mixtures thereof.

18. The packaged item of claim 14, wherein said cooling agent is selected from the group consisting of N₂, CO₂, and mixtures thereof, and wherein said sanitizing agent is selected from the group consisting of:
a) ozone;
b) chlorine dioxide;
c) hydrogen peroxide;
d) chlorine; and
e) mixtures thereof.

19. The packaged item of claim 14, wherein a concentration of said sanitizing agent in said treating agent is about 0.01 to about 10 wt %.

20. The packaged item of claim 14, wherein said sanitizing agent comprises ozone, and wherein a concentration of said ozone in said treating agent is greater than about 1 ppm by weight.

21. The packaged item of claim 20, wherein said concentration of said ozone is about 1 to 20 ppm by weight.

22. A method of processing a target item comprising the steps of:
a) exposing a target item to a treating agent, wherein:
i) said treating agent comprises a sanitizing agent and a cooling agent;
ii) said cooling agent is selected from the group consisting of a liquefied gas, a solid made from a liquefied gas, and mixtures thereof;
iii) said treating agent is in a form selected from the group consisting of a solid form, a liquid form, or combinations thereof when initially exposed to said target item; and
iv) said treating agent is substantially absent water;
b) converting said cooling agent to a gaseous form; and
c) treating said target item with said sanitizing agent.

23. The method of claim 22, wherein said cooling agent is selected from the group consisting of N₂, CO₂, and mixtures thereof.

24. The method of claim 22, wherein said sanitizing agent is selected from the group consisting of:
a) ozone;
b) chlorine dioxide;
c) hydrogen peroxide;
d) chlorine; and
e) mixtures thereof.

25. The method of claim 22, wherein said cooling agent is selected from the group consisting of N₂, CO₂, and mixtures thereof, and wherein said sanitizing agent is selected from the group consisting of:
a) ozone;
b) chlorine dioxide;
c) hydrogen peroxide;
d) chlorine; and
e) mixtures thereof.

26. The method of claim 22, wherein said sanitizing agent comprises ozone, and further comprising the steps of:
a) compressing an ozone-containing feed mixture using a dry gas compression system to form a compressed ozone-containing feed mixture; and
b) combining said compressed ozone-containing feed mixture with said cooling agent to form said treating agent.

27. The method of claim 26, wherein said ozone-containing feed mixture is compressed to a pressure of greater than about 90 psig.

28. The method of claim 26, wherein said ozone-containing feed mixture is compressed to a pressure of greater than 150 about psig.

29. The method of claim 22, wherein said target item, during said exposure step, is in a treatment area selected from the group consisting of:
a) a tunnel;
b) a tumbler;
c) a blender;
d) a plate;
e) a chamber;
f) a vessel;
g) packages;
h) transportation containers; and
i) combinations thereof.

30. The method of claim 22, wherein said sanitizing agent substantially sanitizes said cooling agent.

31. The method of claim 22, further comprising the step of adjusting the pH of the target item.
